(19) United States
(12) Patent Application Publication
(10) Pub. No.: US 2013/0050603 A1
(43) Pub. Date: Feb. 28, 2013

(54) LIQUID CRYSTAL DISPLAY APPARATUS

(71) Applicant: Megumi ISE, Fukaya-shi (JP)

(72) Inventor: Megumi ISE, Fukaya-shi (JP)

(21) Appl. No.: 13/584,220

(22) Filed: Aug. 13, 2012

(30) Foreign Application Priority Data
Aug. 30, 2011 (JP) 2011-187616

(51) Int. Cl. G02F 1/1343; G02F 1/136; G02F 1/1337

(52) U.S. Cl. 349/43; 349/142; 349/123

(57) ABSTRACT

According to one embodiment, a liquid crystal display apparatus includes a first substrate, a second substrate, a liquid crystal layer, and a display area. The pixel electrodes comprise primary pixel electrodes extending in the second direction. The peripheral electrode has a frame shape around an outer periphery of the display area. The common electrode comprises primary common electrodes extending in the second direction, wherein both ends of each of the primary common electrodes are connected with the peripheral electrode.

### CROSS-REFERENCE TO RELATED APPLICATIONS

This application is based upon and claims the benefit of priority from Japanese Patent Application No. 2011-187616, filed Aug. 30, 2011, the entire contents of which are incorporated herein by reference.

### FIELD

Embodiments described herein relate generally to a liquid crystal display apparatus.

### BACKGROUND

Recently, flat display apparatuses have been actively developed, and among others, a liquid crystal display apparatus has been particularly drawing attention for its advantages such as light weight, small thickness, and low power consumption. In particular, regarding an active matrix type liquid crystal display apparatus in which a switching element is incorporated in each pixel, attention has been focused on a structure that uses a lateral electric field (including a fringe electric field), such as an in-plane switching (IPS) mode and a fringe field switching (FFS) mode. The liquid crystal display apparatus of such a lateral electric field mode comprises a pixel electrode and a counterelectrode that are formed in an array substrate, and switches a liquid crystal molecule by a lateral electric field substantially parallel to the main surface of the array substrate.

On the other hand, there has also been suggested a technique for switching liquid crystal molecules by a lateral electric field and an oblique electric field formed between a pixel electrode formed in an array substrate and a common electrode formed in a countersubstrate.

### BRIEF DESCRIPTION OF THE DRAWINGS

FIG. 1 is a diagram schematically showing the configuration and an equivalent circuit of a liquid crystal display apparatus according to one embodiment;

FIG. 2 is a plan view schematically showing a structure example of one pixel when a liquid crystal display panel shown in FIG. 1 is viewed from the side of a countersubstrate;

FIG. 3 is a sectional view schematically showing a sectional structure of the liquid crystal display panel shown in FIG. 2 along line

FIG. 4 is a plan view schematically showing a common electrode shown in FIG. 2 and FIG. 3;

FIG. 5 is a diagram illustrating an electric field formed between a pixel electrode and the common electrode in the liquid crystal display panel shown in FIG. 2, and the relationship between the director and transmittance of liquid crystal molecules associated with the electric field;

FIG. 6 is a plan view schematically showing a modification of the common electrode;

FIG. 7 is a plan view schematically showing another structure example of one pixel when the liquid crystal display panel shown in FIG. 1 is viewed from the side of the countersubstrate, wherein the common electrode shown in FIG. 6 is shown together;

FIG. 8 is a plan view schematically showing another structure example of one pixel when the liquid crystal display panel shown in FIG. 1 is viewed from the side of the countersubstrate, wherein the common electrode shown in FIG. 6 is shown together;

FIG. 9 is a plan view schematically showing another modification of the common electrode;

FIG. 10 is a plan view schematically showing another structure example of one pixel when the liquid crystal display panel shown in FIG. 1 is viewed from the side of the countersubstrate, wherein the common electrode shown in FIG. 9 is shown together; and

FIG. 11 is a plan view schematically showing another structure example of the array substrate of the liquid crystal display panel shown in FIG. 1.

### DETAILED DESCRIPTION

In general, according to one embodiment, there is provided a liquid crystal display apparatus comprising: a first substrate comprising a plurality of pixel electrodes; a second substrate comprising a peripheral electrode and a common electrode; a liquid crystal layer held between the first substrate and the second substrate; and a display area opposing the first substrate, the second substrate, and the liquid crystal layer. The pixel electrodes comprise a plurality of primary pixel electrodes arranged in the display area at intervals in a first direction and a second direction which cross at right angles, and extending in the second direction. The peripheral electrode has a frame shape around an outer periphery of the display area. The common electrode comprises a plurality of primary common electrodes arranged at intervals in the first direction to sandwich the primary pixel electrodes in the first direction, and extending in the second direction, wherein both ends of each of the primary common electrodes are connected with the peripheral electrode.

According to another embodiment, there is provided a liquid crystal display apparatus comprising: a first substrate comprising a plurality of pixel electrodes; a second substrate comprising a peripheral electrode and a common electrode; a liquid crystal layer held between the first substrate and the second substrate; and a display area opposing the first substrate, the second substrate, and the liquid crystal layer. The pixel electrodes comprise a plurality of primary pixel electrodes arranged in the display area at intervals in a first direction and a second direction which cross at right angles, and extending in the second direction, and a plurality of secondary pixel electrodes extending in the first direction, each of the pixel electrodes having a cross-shaped. The peripheral electrode has a frame shape around an outer periphery of the display area. The common electrode comprises a plurality of primary common electrodes arranged at intervals in the first direction to sandwich the primary pixel electrodes in the first direction, and extending in the second direction, wherein both ends of each of the primary common electrodes are connected with the peripheral electrode, and a plurality of secondary common electrodes arranged at intervals in the second direction to sandwich the primary pixel electrodes in the second direction, and extending in the first direction, wherein both ends of each of the secondary common electrodes are connected with the peripheral electrode, the common electrode having a lattice-shaped.

According to another embodiment, there is provided a liquid crystal display apparatus comprising: a countersubstrate comprising a frame-shaped peripheral electrode, a primary common electrode connected with the peripheral electrode, and a secondary common electrode configured to intersect with the primary common electrode and connected with the peripheral electrode; an array substrate comprising a pixel electrode configured to be located parallel to the primary common electrode; a liquid crystal layer held between the countersubstrate and the array substrate and having a thickness smaller than the distance between the primary common electrode and the pixel electrode; and a sealing member surrounding the liquid crystal layer and opposing the end of the peripheral electrode.

Hereinafter, a liquid crystal display apparatus according to one embedment will be described in detail with reference to the drawings. It is to be noted that components having identical or similar functions are provided with the same reference numbers throughout the drawings and are not repeatedly described.

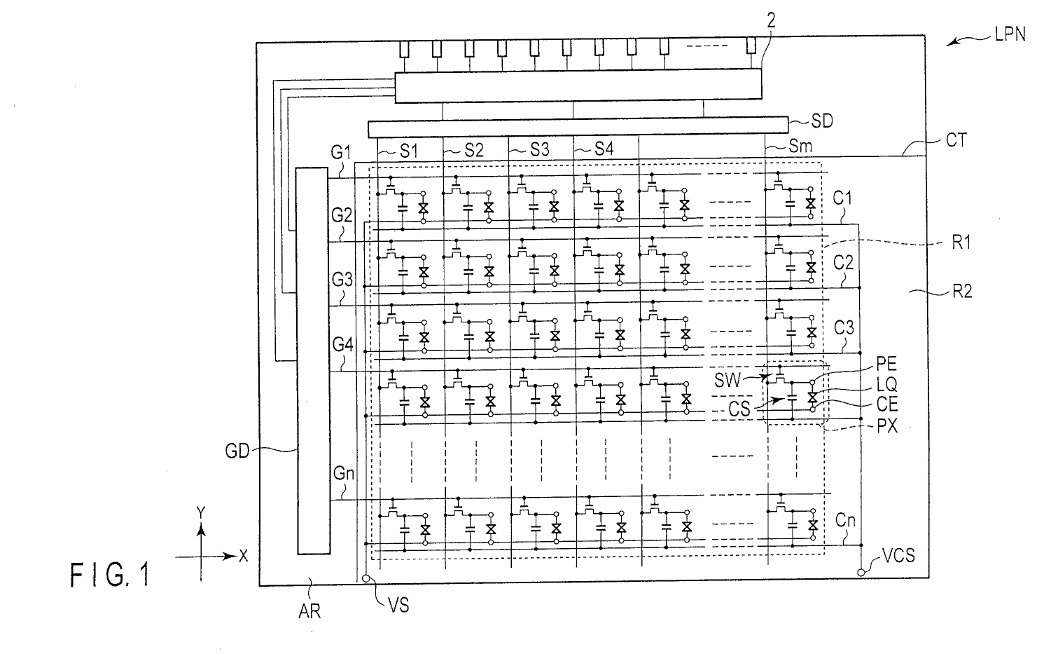

FIG. 1 is a diagram schematically showing the configuration and an equivalent circuit of a liquid crystal display apparatus according to one embodiment.

As shown in FIG. 1, the liquid crystal display apparatus comprises an active matrix type liquid crystal display panel LPN. The liquid crystal display panel LPN comprises an array substrate AR which is a first substrate, a countersubstrate CT which is a second substrate arranged opposite to the array substrate AR, and a liquid crystal layer LQ held between the array substrate AR and the countersubstrate CT. Such a liquid crystal display panel LPN comprises a display area R1 for displaying images. The display area R1 opposes the array substrate AR, the countersubstrate CT, and the liquid crystal layer LQ. A plurality of m×n pixels PX arranged in matrix form are located in the display area R1 (note that m and n are positive integers).

The liquid crystal display panel LPN comprises, in the display area R1, n gate lines G (G1 to Gn), n auxiliary capacitive lines C (C1 to Cn), and m source lines S (S1 to Sm). The gate lines G and the auxiliary capacitive lines C substantially linearly extend, for example, in a first direction X. The gate lines G and the auxiliary capacitive lines C are alternately arranged parallel to one another in a second direction Y that intersects with the first direction X. Here, the first direction X and the second direction Y are substantially perpendicular to each other. The source lines S intersect with the gate lines G and the auxiliary capacitive lines C. The source lines S substantially linearly extend in the second direction Y. The gate lines G, the auxiliary capacitive lines C, and the source lines S do not necessarily have to linearly extend and may be partly bent.

Each of the gate lines G is drawn out of the display area R1, and is connected to a gate driver GD. Each of the source lines S is drawn out of the display area R1, and is connected to a source driver SD. For example, at least a potion of the gate driver GD and the source driver SD is formed in the array substrate AR and connected to a drive IC chip 2 which has a controller therein.

Each of the pixels PX comprises a switching element SW, a pixel electrode PE, and a common electrode CE. A retention capacity Cs is formed, for example, between the auxiliary capacitive line C and the pixel electrode PE. The auxiliary capacitive line C is electrically connected to a voltage applied section VCS to which an auxiliary capacitive voltage is applied.

In the present embodiment, the liquid crystal display panel LPN is configured to have the pixel electrode PE formed in the array substrate AR and at least part of the common electrode CE formed in the countersubstrate CT. An electric field formed between the pixel electrode PE and the common electrode CE is mainly used to switch liquid crystal molecules in the liquid crystal layer LQ. The electric field formed between the pixel electrode PE and the common electrode CE is an oblique electric field slightly tilted relative to an X-Y plane defined by the first direction X and the second direction Y or relative to the main surface of the substrate (or is a lateral electric field substantially parallel to the main surface of the substrate).

The switching element SW comprises, for example, an n-channel thin film transistor (TFT). This switching element SW is electrically connected to the gate line G and the source line S. Such a switching element SW may be either a top gate type or a bottom gate type. Although a semiconductor layer of the switching element SW is made of, for example, polysilicon, the semiconductor layer may otherwise be made of amorphous silicon.

The pixel electrode PE is located in each of the pixels PX, and is electrically connected to the switching element SW. The common electrode CE is shared by and located in the pixel electrodes PE of the pixels PX via the liquid crystal layer LQ. The pixel electrode PE and the common electrode CE are made of a light-transmitting conductive material such as indium tin oxide (ITO) or indium zinc oxide (IZO), but may otherwise be made of other metal materials such as aluminum.

The array substrate AR comprises a power supply VS for applying a voltage (common voltage) to the common electrode CE. This power supply VS is formed, for example, in a non-display area R2 outside the display area R1. The common electrode CE is drawn out of the display area R1, and is electrically connected to the power supply VS via an unshown conductive member.

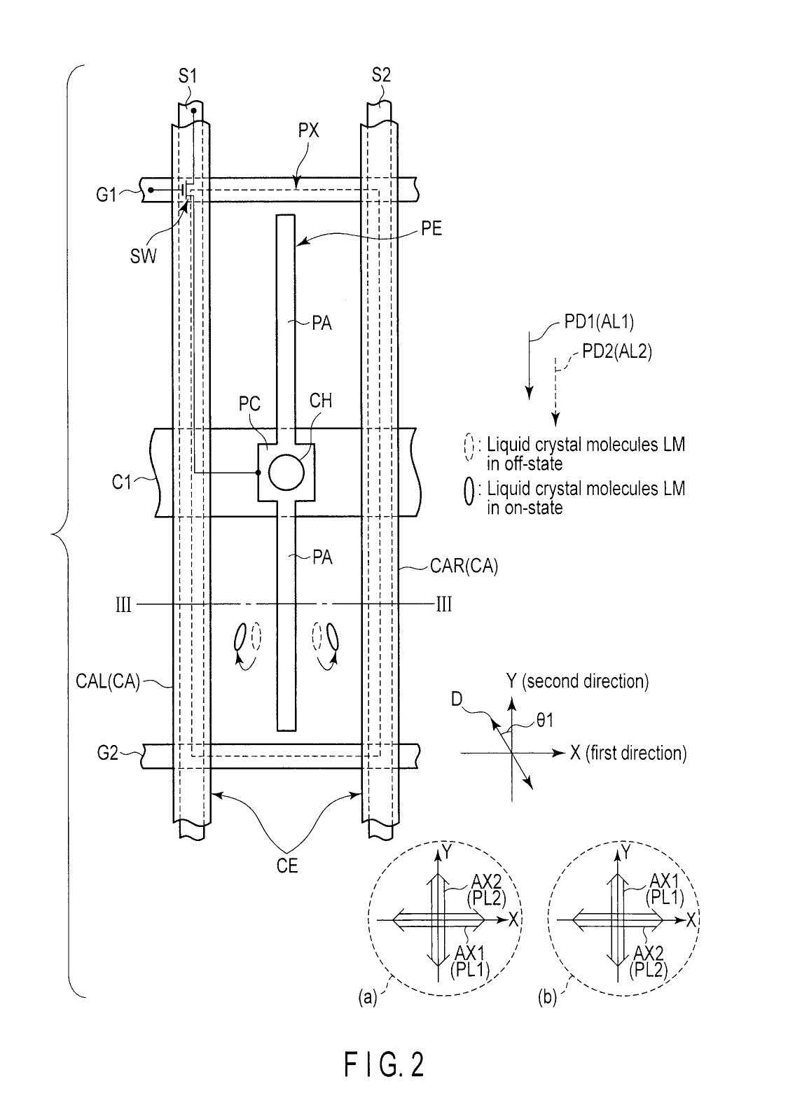

FIG. 2 is a plan view schematically showing a structure example of one pixel PX when the liquid crystal display panel LPN shown in FIG. 1 is viewed from the side of the countersubstrate. Here, a plan view in the X-Y plane is shown.

As shown in FIG. 2, the pixel PX has an oblong shape smaller in the length in the first direction X than in the length in the second direction Y, as indicated by dashed lines. Gate line G1 and gate line G2 extend in the first direction X. The auxiliary capacitive line C1 is located between gate line G1 and gate line G2 that are adjacent to each other. The auxiliary capacitive line C1 extends in the first direction X. Source line S1 and source line S2 extends in the second direction Y. The pixel electrode PE is located between source line S1 and source line S2 that are adjacent to each other. This pixel electrode PE is also located between gate line G1 and gate line G2.

In the example shown, source line S1 is located at the left end of the pixel PX, and source line S2 is located at the right end. Strictly, the source line S1 is located on the border between this pixel PX and the adjacent pixel at its left, and the source line S2 is located on the border between this pixel PX and the adjacent pixel at its right. Gate line G1 is located at the upper end of the pixel PX, and gate line G2 is located at the lower end. Strictly, gate line G1 is located on the border between this pixel PX and the adjacent pixel at its top, and gate line G2 is located on the border between this pixel PX and the adjacent pixel at its bottom. The auxiliary capacitive line C1 is located substantially in the center of the pixel.

In the example shown, the switching element SW is electrically connected to gate line G1 and source line S1. This switching element SW is provided at the intersection of gate line G1 and source line S1. A drain line of the switching element SW extends along source line S1 and the auxiliary capacitive line C1, and is electrically connected to the pixel electrode PE through a contact hole CH formed in a area that opposes the auxiliary capacitive line C1. Such a switching element SW is provided in a area that opposes source line S1 and the auxiliary capacitive line C1, and hardly extends beyond the area that opposes source line S1 and the auxiliary capacitive line C1, thus inhibiting reduction of the area of an opening that contributes to display.

The pixel electrodes PE are arranged at intervals in the first direction X and the second direction Y. Each of the pixel electrodes PE includes a primary pixel electrode PA formed to extend in the second direction Y.

In this embodiment, the pixel electrode PE includes the primary pixel electrode PA and a contact portion PC electrically connected to each other. The primary pixel electrode PA linearly extends up to the vicinities of the upper and lower ends the pixel PX from the contact portion PC in the second direction Y. Such a primary pixel electrode PA is in a belt shape having substantially the same width in the first direction X. The contact portion PC is located in a area that opposes the auxiliary capacitive line C1, and is electrically connected to the switching element SW through the contact hole CH. The contact portion PC is formed to be greater in width than the primary pixel electrode PA.

Such a pixel electrode PE is located at a substantially intermediate position between source line S1 and source line S2, that is, located in the center of the pixel PX. The distance between source line S1 and the pixel electrode PE in the first direction X is substantially equal to the distance between source line S2 and the pixel electrode PE in the first direction X.

The common electrode CE includes a plurality of primary common electrodes CA. In the X-Y plane, the primary common electrodes CA are arranged at intervals in the first direction X, sandwich the primary pixel electrodes PA in the first direction X, and linearly extend in the second direction Y substantially parallel to the primary pixel electrodes PA, respectively. Alternatively, the primary common electrodes CA respectively face the source lines S, and extend substantially parallel to the primary pixel electrodes PA. Such a primary common electrode CA is in a belt shape, and has substantially the same width in the first direction X.

In the example shown, two primary common electrodes CA are arranged parallel to each other in the first direction X, and are located at right and left ends of the pixel PX, respectively. Hereinafter, in order to differentiate these primary common electrodes CA, the left primary common electrode in the diagram is referred to as CAL, and the right primary common electrode in the diagram is referred to as CAR. Primary common electrode CAL faces source line S1, and primary common electrode CAR faces source line S2.

In the pixel PX, primary common electrode CAL is located at the left end, and primary common electrode CAR is located at the right end. Strictly, primary common electrode CAL is located on the border between this pixel PX and the adjacent pixel at its left, and primary common electrode CAR is located on the border between this pixel PX and the adjacent pixel at its right.

With regard to the positional relation between the pixel electrode PE and the primary common electrode CA, the pixel electrodes PE and the primary common electrodes CA are alternately arranged in the first direction X. The pixel electrodes PE and the primary common electrodes CA are arranged substantially parallel to each other. In this case, in the X-Y plane, none of the primary common electrodes CA oppose the pixel electrodes PE.

That is, one pixel electrode PE is located between primary common electrode CAL and primary common electrode CAR that are adjacent to each other. In other words, primary common electrode CAL and primary common electrode CAR are arranged on two sides across the position immediately above the pixel electrode PE. Alternatively, the pixel electrode PE is located between primary common electrode CAL and primary common electrode CAR. Thus, primary common electrode CAL, the primary pixel electrode PA, and primary common electrode CAR are arranged in the first direction X in this order.

The distance between the pixel electrode PE and the common electrode CE in the first direction X is substantially fixed. That is, the distance between primary common electrode CAL and the primary pixel electrode PA in the first direction X is substantially equal to the distance between primary common electrode CAR and the primary pixel electrode PA in the first direction X.

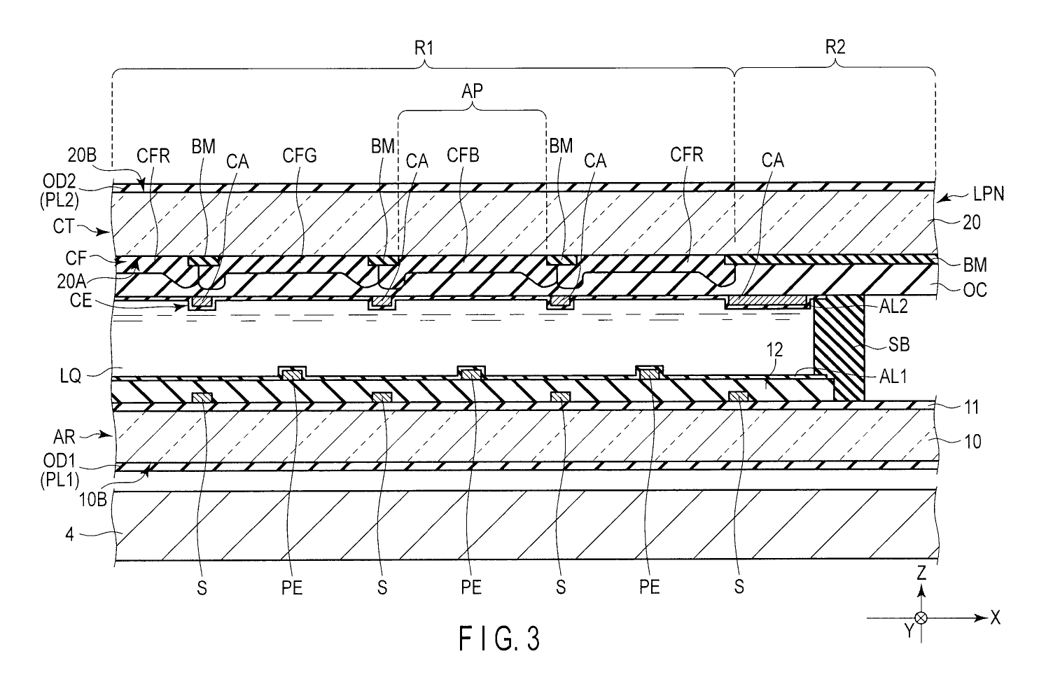

FIG. 3 is a sectional view schematically showing a sectional structure of the liquid crystal display panel LPN shown in FIG. 2 along line Here, parts necessary for an explanation are only shown. As shown in FIG. 3, a backlight unit 4 is located in the rear of the array substrate AR that constitutes the liquid crystal display panel LPN. Various forms of backlight units 4 are applicable. Moreover, a backlight unit that uses a light-emitting diode (LED) or a cold cathode fluorescent lamp (CCFL) as a light source is also applicable. The detailed structure of the backlight unit is not described.

The array substrate AR is formed by using a light-transmitting first insulating substrate 10. The source lines S are provided on a first interlayer insulating film 11, and are covered by a second interlayer insulating film 12. The gate lines and the auxiliary capacitive lines that are not shown are located, for example, between the first insulating substrate 10 and the first interlayer insulating film 11. The pixel electrodes PE are provided on the second interlayer insulating film 12. The pixel electrode PE is located inside the positions immediately above the adjacent source lines S.

A first alignment film AL1 is located on the surface of the array substrate AR facing the countersubstrate CT, and extends over substantially the entire display area R1. The first alignment film AL1 covers the pixel electrode PE and others, and is also located on the second interlayer insulating film 12. Such a first alignment film AL1 is made of a material that shows a horizontal alignment property.

The array substrate AR may further comprise part of the common electrode CE.

The countersubstrate CT is formed by using a light-transmitting second insulating substrate 20. The countersubstrate CT comprises black matrix BM, color filters CF, an overcoat layer OC, the common electrode CE, and a second alignment film AL2.

The black matrix BM separates the pixels PX, and form an aperture AP facing the pixel electrode PE.

That is, the black matrix BM is located to face wiring portions such as the source lines S, the gate lines, the auxiliary capacitive lines, and the switching element. Although a part of the black matrix BM that extends in the second direction Y is only shown here, the black matrix BM may comprise a part that extends in the first direction X. This black matrix BM is located in an inner surface 20A of the second insulating substrate 20 facing the array substrate AR.

The color filter CF is located to correspond to each pixel PX. That is, the color filter CF is located in the aperture AP in the inner surface 20A of the second insulating substrate 20, and is partly put on the black matrix BM. The color filters CF located in the pixels PX adjacent in the first direction X have different colors. For example, the color filters CF are made of resin materials having three primary colors including red, green, and blue. The red filter CFR made of red resin material is located to correspond to the red pixel. The blue filter CFB made of blue resin material is located to correspond to the blue pixel. The green filter CFG made of green resin material is located to correspond to the green pixel. The border between the color filters CF is located to oppose the black matrix BM.

The overcoat layer OC covers the color filter CF. This overcoat layer OC reduces the influence of the unevenness of the surface of the color filter CF.

The common electrode CE is provided on the side of the overcoat layer OC facing the array substrate AR. The second alignment film AL2 is located on the surface of the countersubstrate CT facing the array substrate AR, and extends over substantially the entire display area R1. This second alignment film AL2 covers the common electrode CE, the overcoat layer OC, and others. Such a second alignment film AL2 is made of a material that shows a horizontal alignment property.

The first alignment film AL1 and the second alignment film AL2 are alignment-treated (for example, rubbing and photo alignment treatment) for the initial alignment of the liquid crystal molecules in the liquid crystal layer LQ. A first alignment treatment direction PD1 in which the first alignment film AL1 initially aligns the liquid crystal molecules is parallel to and is opposite to or the same as a second alignment treatment direction PD2 in which the second alignment film AL2 initially aligns the liquid crystal molecules. For example, the first alignment treatment direction PD1 and the second alignment treatment direction PD2 are substantially parallel to and in the same direction as the second direction Y, as shown in FIG. 2.

In this embodiment, the first alignment film AL1 and the second alignment film AL2 can initially align the liquid crystal molecules located in their vicinities in the second direction Y.

The array substrate AR and the countersubstrate CT described above are located so that the first alignment film AL1 and the second alignment film AL2 face each other. In this case, a predetermined cell gap, for example, a cell gap of 2 to 7 μm is formed between the first alignment film AL1 of the array substrate AR and the second alignment film AL2 of the countersubstrate CT by columnar spacers which are integrally formed on one of the substrates, for example, by a resin material. The array substrate AR and the countersubstrate CT are sealed together by a sealing member SB outside the display area R1 so that the predetermined cell gap is formed. The thickness (cell gap) of the liquid crystal layer is smaller than the distance between the primary common electrode and the primary pixel electrode.

The liquid crystal layer LQ is held by the cell gap formed between the array substrate AR and the countersubstrate CT, and is located between the first alignment film AL1 and the second alignment film AL2. Such a liquid crystal layer LQ has, for example, positive dielectric anisotropy, that is, is made of p-type liquid crystal.

A first optical element OD1 is affixed, for example, by an adhesive agent to the outer surface of the array substrate AR, that is, an outer surface 10B of the first insulating substrate 10 that constitutes the array substrate AR. This first optical element OD1 is located on the side of the liquid crystal display panel LPN facing the backlight unit 4, and controls the polarization of incoming light entering the liquid crystal display panel LPN from the backlight unit 4. This first optical element OD1 includes a first polarizer PL1 having a first polarization axis (or first absorption axis) AX1.

A second optical element OD2 is affixed, for example, by an adhesive agent to the outer surface of the countersubstrate CT, that is, an outer surface 20B of the second insulating substrate 20 that constitutes the countersubstrate CT. This second optical element OD2 is located on the display surface of the liquid crystal display panel LPN, and controls the polarization of outgoing light coming out of the liquid crystal display panel LPN. This second optical element OD2 includes a second polarizer PL2 having a second polarization axis (or second absorption axis) AX2.

As the first polarization axis AX1 and the second polarization axis AX2 are, for example, perpendicularly positioned, the first polarizer PL1 and the second polarizer PL2 are in the cross-Nicol configuration. In this case, one of the polarizers is located so that, for example, its polarization axis is parallel to or perpendicular to the initial alignment direction of the liquid crystal molecules, that is, the first alignment treatment direction PD1 or the second alignment treatment direction PD2. When the initial alignment direction is parallel to the second direction Y, the polarization axis of one of the polarizers is parallel to the second direction Y or parallel to the first direction X.

In FIG. 2, in an example indicated by (a), the first polarizer PL1 is located so that its first polarization axis AX1 is perpendicular to the initial alignment direction (second direction Y) of liquid crystal molecules LM (i.e., parallel to the first direction X), and the second polarizer PL2 is located so that its second polarization axis AX2 is parallel to the initial alignment direction of the liquid crystal molecules LM (i.e., parallel to the second direction Y).

In FIG. 2, in an example indicated by (b), the second polarizer PL2 is located so that its second polarization axis AX2 is perpendicular to the initial alignment direction (second direction Y) of the liquid crystal molecules LM (i.e., parallel to the first direction X), and the first polarizer PL1 is located so that its first polarization axis AX1 is parallel to the initial alignment direction of the liquid crystal molecules LM (i.e., parallel to the second direction Y).

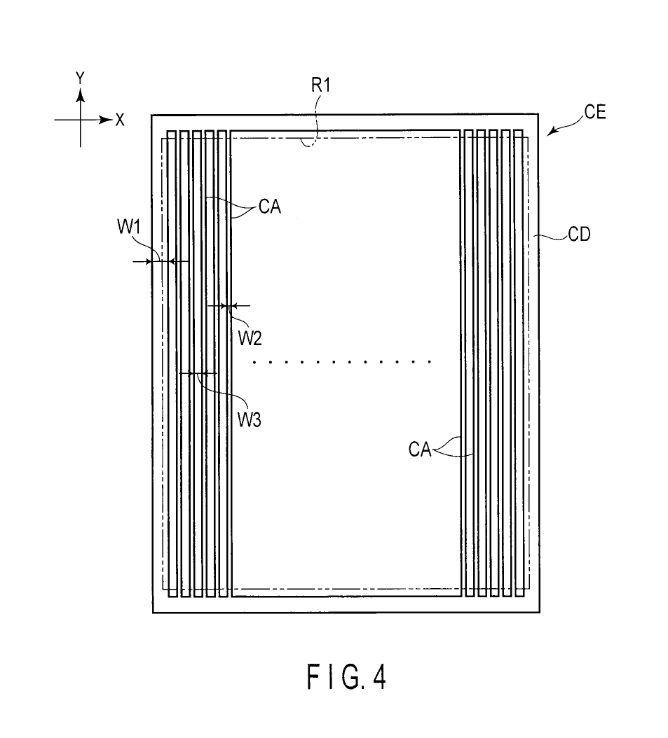

FIG. 4 is a plan view schematically showing the common electrode CE shown in FIG. 2 and FIG. 3.

As shown in FIG. 2, FIG. 3, and FIG. 4, the common electrode CE further includes a peripheral electrode CD. The peripheral electrode CD is located in the non-display area R2, and is formed to have a frame shape around the outer periphery of the display area R1. In this embodiment, as the display area R1 is rectangular, the peripheral electrode CD is formed into a rectangular shape. Primary common electrode CAL of the pixel located at the left end of the display area R1 is connected to the peripheral electrode CD, and extends toward the non-display area R2. Similarly, primary common electrode CAR of the pixel located at the right end of the display area R1 is connected to the peripheral electrode CD, and extends toward the non-display area R2. When the source lines S are located at the right and left borders between the display area R1 and the non-display area R2, the center lines of the source lines S are the borders between the display area R1 and the non-display area R2. When no source lines S are located at both ends of the display area R1 and when the common electrode is not located on the countersubstrate CT that faces the source lines S in the display area R1, the ends, which are on the side of the non-display area R2, of the pixels located at the right and left ends of the display area R1 are the borders between the display area R1 and the non-display area R2.

Regarding the upper and lower borders between the display area R1 and the non-display area R2, the ends, which are on the side of the non-display area R2, of the pixels located on the upper and lower ends of the display area R1 are the borders. The common electrode CE in the display area R1 is connected to the peripheral electrode CD over the upper and lower borders between the display area R1 and the non-display area R2. All the pixels in the display area R1 are the same size.

Width W1 of the peripheral electrode CD is larger than width W2 of the primary common electrode CA. Moreover, width W3 between the end of the primary common electrode CA and the end of the adjacent primary common electrode CA, that is, width W3 of the aperture is larger than width W2 and smaller than width W1.

Both ends of each of the primary common electrodes CA are connected to the peripheral electrode CD. The primary common electrodes CA and the peripheral electrode CD are integrally formed. Therefore, the primary common electrodes CA (CAL and CAR) are electrically connected to each other outside the display area R1 via the peripheral electrode CD. The power supply VS is connected to the peripheral electrode CD via the conductive member in at least one place. The voltage (common voltage) provided from the power supply VS is applied to the primary common electrodes CA via the peripheral electrode CD.

The operation of the liquid crystal display panel LPN having the above configuration will now be described.

As shown in FIG. 2 and FIG. 3, when no voltage is applied to the liquid crystal layer LQ, that is, when no electric field is formed between the pixel electrode PE and the common electrode CE (off-state), the major axes of the liquid crystal molecules LM of the liquid crystal layer LQ are aligned to be in the first alignment treatment direction PD1 of the first alignment film AL1 and in the second alignment treatment direction PD2 of the second alignment film AL2. This off-state corresponds to an initial alignment state, and the alignment direction of the liquid crystal molecules LM in the off-state corresponds to the initial alignment direction.

Strictly, the liquid crystal molecules LM are not necessarily aligned parallel to the X-Y plane, and are often pretilted. Therefore, the initial alignment direction of the liquid crystal molecules LM here is the direction in which the major axes of the liquid crystal molecules LM in the off-state are orthogonally projected in the X-Y plane. In the following explanation, for simplicity, the liquid crystal molecules LM are aligned parallel to the X-Y plane, and are rotated in a plane parallel to the X-Y plane.

Here, both the first alignment treatment direction PD1 and the second alignment treatment direction PD2 are substantially parallel to the second direction Y. In the off-state, the major axes of the liquid crystal molecules LM are initially aligned in a direction substantially parallel to the second direction Y, as indicated by dashed lines in FIG. 2. That is, the initial alignment direction of the liquid crystal molecules LM is parallel to the second direction Y (or 0° to the second direction Y).

When the first alignment treatment direction PD1 and the second alignment treatment direction PD2 are parallel and in the same direction as in the example shown, the liquid crystal molecules LM are aligned substantially horizontally (at a pretilt angle of about zero) in the vicinity of the intermediate part of the liquid crystal layer LQ in the section of the liquid crystal layer LQ. The liquid crystal molecules LM are aligned at such a pretilt angle that the molecules in the vicinity of the first alignment film AL1 and the molecules in the vicinity of the second alignment film AL2 are symmetrical with respect to this part (splay alignment).

Here, if the first alignment film AL1 is aligned in the first alignment treatment direction PD1, the liquid crystal molecules LM in the vicinity of the first alignment film AL1 are initially aligned in the first alignment treatment direction PD1. If the second alignment film AL2 is aligned in the second alignment treatment direction PD2, the liquid crystal molecules LM in the vicinity of the second alignment film AL2 are initially aligned in the second alignment process direction PD2. When the first alignment treatment direction PD1 and the second alignment treatment direction PD2 are parallel and in the same direction, the liquid crystal molecules LM are splay-aligned as described above, and the alignment of the liquid crystal molecules LM in the vicinity of the first alignment film AL1 on the array substrate AR and the alignment of the liquid crystal molecules LM in the vicinity of the second alignment film AL2 on the countersubstrate CT are vertically symmetrical with respect to the intermediate part of the liquid crystal layer LQ as described above. This also provides optical compensation in a direction tilted from the normal direction of the substrate. Therefore, when the first alignment treatment direction PD1 and the second alignment treatment direction PD2 are parallel and in the same direction, there is little leakage of light in the case of black display, thereby enabling a high contrast ratio and improved display quality.

When the first alignment treatment direction PD1 and the second alignment treatment direction PD2 are parallel and in the opposite directions, the liquid crystal molecules LM are aligned at a substantially uniform pretilt angle in the vicinity of the first alignment film AL1, in the vicinity of the second alignment film AL2, and in the intermediate part of the liquid crystal layer LQ in the section of the liquid crystal layer LQ (homogeneous alignment).

Backlight from the backlight unit 4 partly passes through the first polarizer PL1, and enters the liquid crystal display panel LPN. The polarization of the light which has entered the liquid crystal display panel LPN varies depending on the alignment state of the liquid crystal molecules LM when the light passes through the liquid crystal layer LQ. In the off-state, the light which has passed through the liquid crystal layer LQ is absorbed by the second polarizer PL2 (black display).

In the meantime, when a voltage is applied to the liquid crystal layer LQ, that is, when an electric field is formed between the pixel electrode PE and the common electrode CE (on-state), a lateral electric field (or an oblique electric field) substantially parallel to the substrate is formed between the pixel electrode PE and the common electrode CE. The major axes of the liquid crystal molecules LM are rotated in a plane substantially parallel to the X-Y plane under the influence of the electric field, as indicated by continuous lines in the drawing.

In the example shown in FIG. 2, the liquid crystal molecules LM in a area between the pixel electrode PE and primary common electrode CAL are rotated clockwise relative to the second direction Y, and are aligned toward the lower left in the drawing. The liquid crystal molecules LM in a area between the pixel electrode PE and primary common electrode CAR are rotated counterclockwise relative to the second direction Y, and are aligned toward the lower right in the drawing.

When an electric field is thus formed between the pixel electrode PE and the common electrode CE in each of the pixels PX, the alignment direction of the liquid crystal molecules LM is divided into a plurality of directions across the pixel electrode PE, and a domain is formed in each alignment direction. That is, a plurality of domains are formed in one pixel PX.

In this on-state, the backlight which has entered the liquid crystal display panel LPN from the backlight unit 4 partly passes through the first polarizer PL1, and enters the liquid crystal display panel LPN. The backlight which has entered the liquid crystal layer LQ changes its polarization state. In this on-state, at least part of the light which has passed through the liquid crystal layer LQ passes through the second polarizer PL2 (white display).

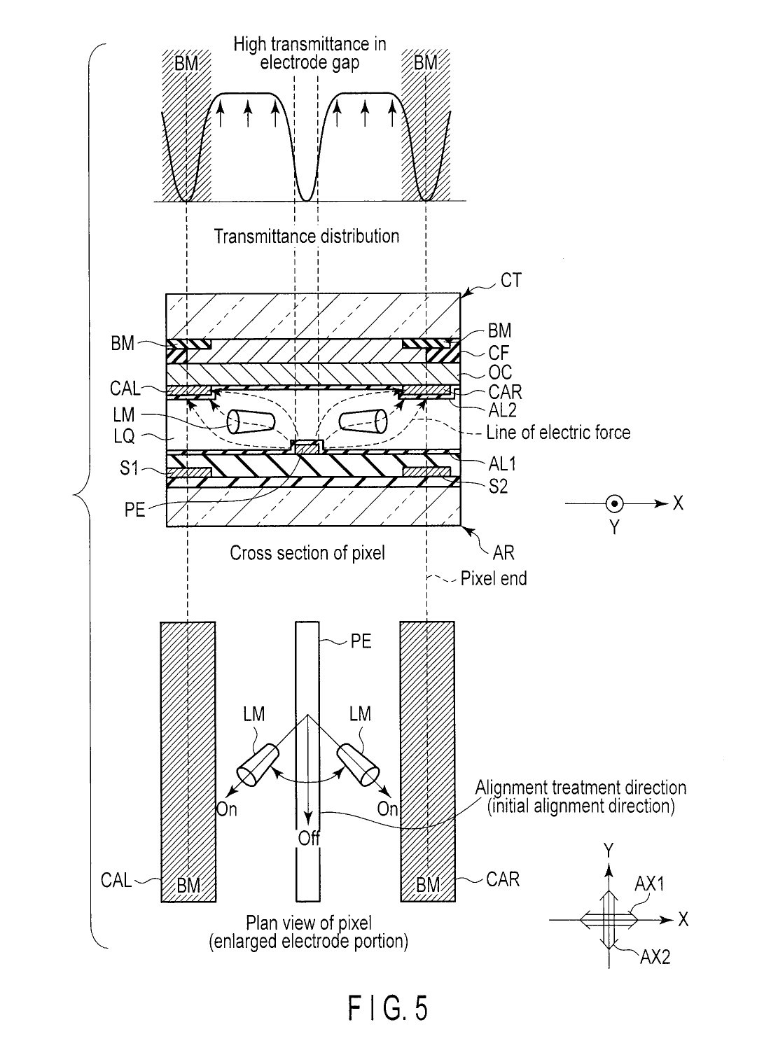

FIG. 5 is a diagram illustrating an electric field formed between the pixel electrode PE and the common electrode CE in the liquid crystal display panel LPN shown in FIG. 2, and the relationship between the director and transmittance of the liquid crystal molecules LM associated with the electric field.

As shown in FIG. 5, in the off-state, the liquid crystal molecules LM are initially aligned in a direction substantially parallel to the second direction Y. In the on-state in which a potential difference is generated between the pixel electrode PE and the common electrode CE, the optical modification rate of the liquid crystal is maximized (i.e., the transmittance in the aperture is maximized) when the director of the liquid crystal molecules LM (or the direction of the major axes of the liquid crystal molecules LM) is shifted about 45° in the X-Y plane relative to the first polarization axis AX1 of the first polarizer PL1 and the second polarization axis AX2 of the second polarizer PL2.

In the example shown, in the on-state, the director of the liquid crystal molecules LM between primary common electrode CAL and the pixel electrode PE is substantially parallel to an azimuth of 45-225° in the X-Y plane, and the director of the liquid crystal molecules LM between primary common electrode CAR and the pixel electrode PE is substantially parallel to an azimuth of 135-315° in the X-Y plane, so that a peak transmittance is obtained. Here, if attention is focused on a transmittance distribution per pixel, transmittance is substantially zero on the pixel electrode PE and on the common electrode CE, while a high transmittance is obtained over the entire area in an electrode gap between the pixel electrode PE and the common electrode CE.

Primary common electrode CAL located immediately above source line S1 and primary common electrode CAR located immediately above source line S2 respectively face the black matrix BM. However, both primary common electrode CAL and primary common electrode CAR have a width equal to or less than the width of the black matrix BM in the first direction X, and do not extend toward the pixel electrode PE from the position that opposes the black matrix BM. Therefore, the aperture contributing to display per pixel corresponds to the areas between the pixel electrode PE, and primary common electrode CAL as well as primary common electrode CAR out of the area between the black matrix BM or between source line S1 and source line S2.

According to the liquid crystal display apparatus having the configuration described above, the liquid crystal display apparatus comprises the array substrate AR including the pixel electrodes PE that include the primary pixel electrodes PA, the countersubstrate CT including the common electrode CE that includes the peripheral electrode CD and the primary common electrodes CA, the liquid crystal layer LQ, and the display area R1.

The peripheral electrode CD is formed to have a frame shape around the outer periphery of the display area R1. Each of the primary common electrodes CA extends in the second direction Y, and both ends of each of the primary common electrodes CA are connected to the peripheral electrode CD. A voltage (common voltage) can be applied to the primary common electrode CA from at least one of the upper side and lower side of the peripheral electrode CD even if the primary common electrode CA is partly broken. Thus, the probability that the common electrode CA may not partly function as an electrode can be reduced. It is thereby possible to reduce the disturbance of the electric field applied to the liquid crystal layer LQ and inhibit the decrease of the display quality.

The potential of the peripheral electrode CD may become unstable as the peripheral electrode CD becomes farther from the place where the voltage (common voltage) is applied. However, width W1 of the peripheral electrode CD is larger than width W2 of the primary common electrode CA, and the electric resistance value of the peripheral electrode CD is lower than the electric resistance value of the primary common electrode CA. It is thereby possible to inhibit the variation of the potential in the peripheral electrode CD (common electrode CE), and set a uniform potential over the entire peripheral electrode CD (common electrode CE). Thus, flickering can be reduced. Particularly, flickering can be reduced in the peripheral edge of the display area R1.

The voltage (common voltage) is applied to at least one place of the peripheral electrode CD (common electrode CE), but may be applied to two or more places. This makes it possible to set a more uniform potential over the entire peripheral electrode CD (common electrode CE).

The overcoat layer OC shows the property of easily letting water through. However, the common electrode CE provided on the overcoat layer OC is made of ITO, and shows the property of not letting water through. Thus, the common electrode CE can reduce the infiltration passage of water from the countersubstrate CT to the array substrate AR via the overcoat layer OC.

The peripheral electrode CD is formed to surround the display area R1. In other words, the peripheral electrode CD is located on the overcoat layer OC of the non-display area R2 from the border between the display area R1 and the non-display area R2 to the sealing member SB. That is, the peripheral electrode CD covers the overcoat layer OC of the non-display area R2. It is therefore possible to block the infiltration passage of water from the countersubstrate CT to the array substrate AR in the outer periphery of the display area R1 (the non-display area R2, a frame area).

As described above, the infiltration of water from the outside can be reduced, so that the erosion of the lines can be prevented in the array substrate AR, and burn-in and flickering can be prevented in the liquid crystal layer LQ.

As a result, it is possible to provide a liquid crystal display apparatus in which the deterioration of the display quality can be inhibited.

Furthermore, according to the present embodiment, a high transmittance can be obtained in the electrode gap between the pixel electrode PE and the common electrode CE. Therefore, in order to sufficiently increase the transmittance per pixel, it is possible to increase the inter-electrode distances between the pixel electrode PE, and primary common electrode CAL as well as primary common electrode CAR. Moreover, for product specifications different in pixel pitch, a peak condition of a transmittance distribution shown in FIG. 5 can be used by changing the inter-electrode distance (i.e., by changing the location of the primary common electrode CA relative to the pixel electrode PE located substantially in the center of the pixel PX). That is, in the display mode according to the present embodiment, the microprocessing of the electrodes is not always needed from the product specification having a relatively large pixel pitch and relatively low resolution to the product specification having a relatively small pixel pitch and relatively high resolution, and products with various pixel pitches can be provided by setting the inter-electrode distance. Therefore, it is possible to readily fulfill demands for higher transmittance and higher resolution.

According to the present embodiment, as shown in FIG. 4, the transmittance is sufficiently reduced if attention is focused on a transmittance distribution in the area that opposes the black matrix BM. The reason is that there is no electric field leakage outside the pixel from the position of the common electrode CE and that no unwanted lateral electric field is generated between the pixels adjacent across the black matrix BM so that the liquid crystal molecules in the area that opposes the black matrix BM maintains the initial alignment state as in the off-state (or the black display). Therefore, even when the color filters of the adjacent pixels are different, the mixing of colors can be inhibited, and reduction of color reproduction and reduction of the contrast ratio can be inhibited.

When the array substrate AR and the countersubstrate CT are out of alignment, the horizontal inter-electrode distance of the common electrodes CE on two sides across the pixel electrode PE may vary. However, such misalignment is caused in all the pixels PX, and therefore produces no difference of electric field distribution among the pixels PX and has a significantly small influence on the display of images. Even if the array substrate AR and the countersubstrate CT are out of alignment, unwanted electric field leakage to the adjacent pixels can be inhibited. Therefore, even when the color filters of the adjacent pixels are different, the mixing of colors can be inhibited, and reduction of color reproduction and reduction of the contrast ratio can be inhibited.

According to the present embodiment, each of the primary common electrodes CA faces the source line S. When primary common electrode CAL and primary common electrode CAR are respectively located immediately above source line S1 and source line S2, the aperture AP can be expanded and the transmittance of the pixel PX can be improved as compared with the case where primary common electrode CAL and primary common electrode CAR are located closer to the pixel electrode PE than source line S1 and source line S2.

Primary common electrode CAL and primary common electrode CAR are respectively located immediately above source line S1 and source line S2, so that the inter-electrode distances between the pixel electrode PE, and primary common electrode CAL as well as primary common electrode CAR can be increased, and a more horizontal lateral electric field can be formed. This makes it possible to maintain a greater view angle which is an advantage of, for example, an IPS mode which is a conventional configuration.

According to the present embodiment, a plurality of domains can be formed in one pixel. Thus, the view angle can be optically compensated in a plurality of directions, and a greater view angle can be obtained.

In the above-described example, the liquid crystal layer LQ has positive dielectric anisotropy, so that the initial alignment direction of the liquid crystal molecules LM is parallel to the second direction Y. However, as shown in FIG. 2, the initial alignment direction of the liquid crystal molecules LM may be a diagonal direction D that diagonally intersects with the second direction Y. Here, an angle θ1 of an initial alignment direction D with the second direction Y is an angle more than 0° and less than 45°. The angle θ1 is highly effective in controlling the alignment of the liquid crystal molecules LM when about 5 to 30°, preferably 20° or less. That is, the initial alignment direction of the liquid crystal molecules LM is preferably substantially parallel to a direction that is angled at 0 to 20° with the second direction Y.

In other words, the first alignment film AL1 is preferably formed so that the liquid crystal molecules LM located in the vicinity of the first alignment film AL1 are initially aligned in the second direction Y or a direction tilted at 20° or less from the second direction Y. The second alignment film AL2 is also preferably formed so that the liquid crystal molecules LM located in the vicinity of the second alignment film AL2 are initially aligned in the second direction Y or a direction tilted at 20° or less from the second direction Y.

The liquid crystal layer LQ has positive dielectric anisotropy in the above-described example, but may have negative dielectric anisotropy, that is, may be made of n-type liquid crystal. However, although not described in detail, the polarity of the dielectric anisotropy is reversed, so that the angle θ1 is preferably 45 to 90°, particularly preferably 70° or more in the case of a negative liquid crystal material.

In other words, the first alignment film AL1 is preferably formed so that the liquid crystal molecules LM located in the vicinity of the first alignment film AL1 are initially aligned in the first direction X or a direction tilted at 20° or less from the first direction X. The second alignment film AL2 is also preferably formed so that the liquid crystal molecules LM located in the vicinity of the second alignment film AL2 are initially aligned in the first direction X or a direction tilted at 20° or less from the first direction X.

Almost no lateral electric field is formed (or no electric field sufficient to drive the liquid crystal molecules LM is formed) on the pixel electrode PE or the common electrode CE even in the on-state, so that the liquid crystal molecules LM hardly move from the initial alignment direction as in the off-state. Therefore, even if the pixel electrode PE and the common electrode CE are made of a light-transmitting conductive material such as ITO, the backlight hardly passes through these areas and hardly contributes to display in the on-state. Therefore, the pixel electrode PE and the common electrode CE do not necessarily have to be made of a transparent conductive material, and may be made of a conductive material such as aluminum, silver, or copper.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the shape of the common electrode CE is not limited to the example shown in FIG. 4, and may be variously modified. The structure of the pixel PX is not limited to the example shown in FIG. 2 either, and may be variously modified in accordance with the shape of the common electrode CE.

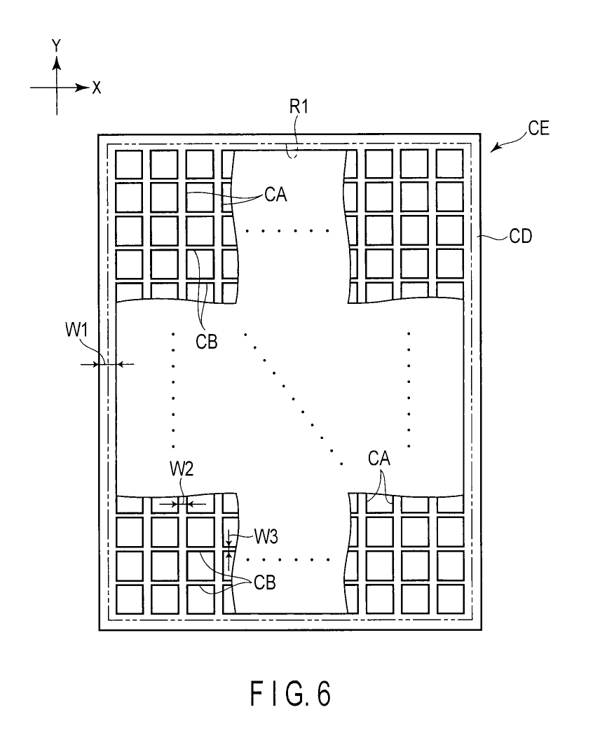

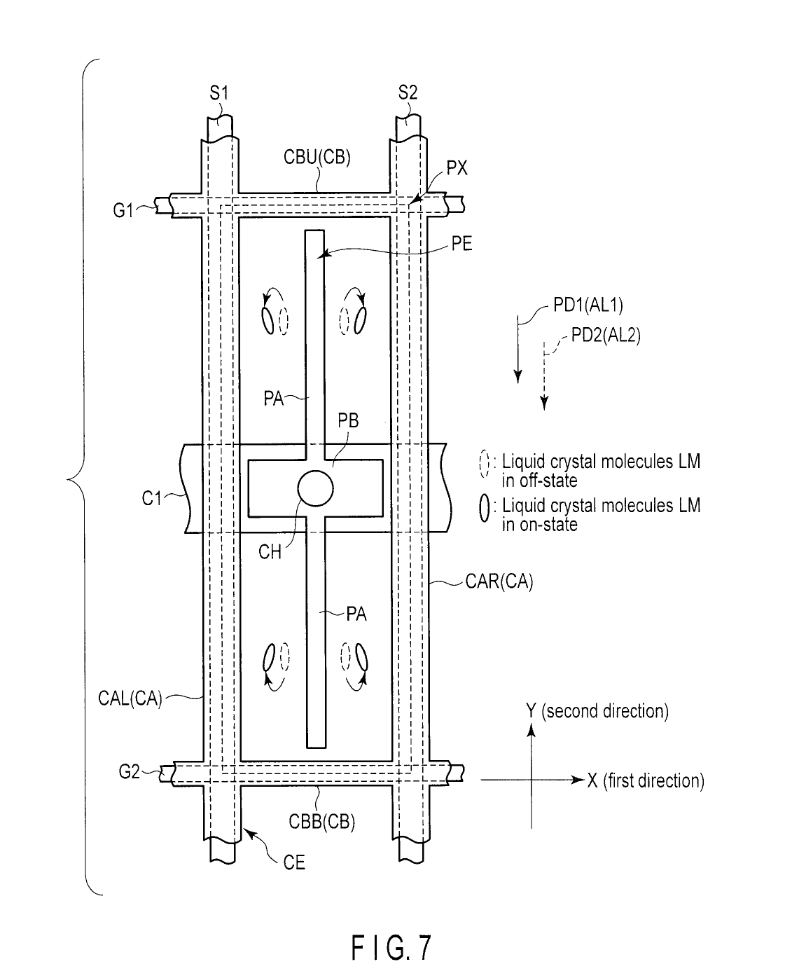

FIG. 6 is a plan view schematically showing a modification of the common electrode CE. FIG. 7 is a plan view schematically showing another structure example of one pixel PX when the liquid crystal display panel shown in FIG. 1 is viewed from the side of the countersubstrate, wherein the common electrode shown in FIG. 6 is shown together.

As shown in FIG. 6 and FIG. 7, the common electrode CE further includes a plurality of secondary common electrodes CB. The secondary common electrodes CB are arranged at intervals in the second direction Y to sandwich the primary pixel electrodes PA in the second direction Y. The secondary common electrodes CB extend in the first direction X. Width W1 of the peripheral electrode CD is larger than width W2 of the primary common electrode CA and width W3 of the secondary common electrode CB.

Both ends of each of the secondary common electrodes CB are connected to the peripheral electrode CD. The secondary common electrodes CB are formed integrally or continuously with the primary common electrodes CA and the peripheral electrode CD. Therefore, the secondary common electrodes CB are (CBU and CBB) are electrically connected to the primary common electrodes CA, and also electrically connected to each other outside the display area R1 via the peripheral electrode CD. The voltage (common voltage) provided from the power supply VS is applied to the primary common electrodes CA and the secondary common electrodes CB via the peripheral electrode CD.

As shown in FIG. 7, the structure example of the pixel PX is different from the structure example of the pixel shown in FIG. 2 in that the pixel electrode PE is cross-shaped and in that the common electrode CE is lattice-shaped to surround one pixel PX.

That is, the pixel electrode PE comprises the primary pixel electrode PA and a secondary pixel electrode PB electrically connected to each other. The primary pixel electrode PA linearly extends in the second direction Y from the secondary pixel electrode PB to the vicinities of the upper and lower ends of the pixel PX. The secondary pixel electrode PB extends in the first direction X. The secondary pixel electrode PB is located in a area that opposes the auxiliary capacitive line C1, and is electrically connected to the switching element through the contact hole CH. In the example shown, the secondary pixel electrode PB is provided substantially in the center of the pixel PX, and the pixel electrode PE is cross-shaped.

The secondary common electrodes CB face the respective gate lines G. In the example shown, two secondary common electrodes CB are arranged parallel to each other in the first direction X. Hereinafter, in order to differentiate these secondary common electrodes CB, the upper secondary common electrode in the diagram is referred to as CBU, and the lower secondary common electrode in the diagram is referred to as CBB. The secondary common electrode CBU is located at the upper end of the pixel PX, and faces gate line G1. That is, the secondary common electrode CBU is located on the border between this pixel PX and the upper adjacent pixel. The secondary common electrode CBB is located at the lower end of the pixel PX, and faces gate line G2. That is, the secondary common electrode CBB is located on the border between this pixel PX and the lower adjacent pixel.

With regard to the positional relation between the pixel electrode PE and the common electrode CE, the primary pixel electrode PA and the primary common electrodes CA are alternately arranged in the first direction X, and the secondary pixel electrode PB and the secondary common electrode CB are alternately arranged in the second direction Y. That is, one primary pixel electrode PA is located between primary common electrode CAL and primary common electrode CAR that are adjacent to each other, and primary common electrode CAL, the primary pixel electrode PA, and primary common electrode CAR are arranged in the first direction X in this order. One secondary pixel electrode PB is located between the secondary common electrode CBB and the secondary common electrode CBU that are adjacent to each other, and the secondary common electrode CBB, the secondary pixel electrode PB, and the secondary common electrode CBU are arranged in the second direction Y in this order.

According to such a configuration example, the major axes of the liquid crystal molecules LM initially aligned in the second direction Y in the off-state are rotated in a plane substantially parallel to the X-Y plane under the influence of the electric field generated between the pixel electrode PE and the common electrode CE in the on-state, as indicated by solid lines in the drawing. The liquid crystal molecules LM in a area surrounded by the pixel electrode PE, primary common electrode CAL and the secondary common electrode CBB are rotated clockwise relative to the second direction Y, and are aligned toward the lower left in the drawing. The liquid crystal molecules LM in a area surrounded by the pixel electrode PE, primary common electrode CAR and the secondary common electrode CBB are rotated counterclockwise relative to the second direction Y, and are aligned toward the lower left in the drawing. The liquid crystal molecules LM in a area surrounded by the pixel electrode PE, primary common electrode CAL and the secondary common electrode CBU are rotated counterclockwise relative to the second direction Y, and are aligned toward the lower left in the drawing. The liquid crystal molecules LM in a area surrounded by the pixel electrode PE, primary common electrode CAR and the secondary common electrode CBU are rotated clockwise relative to the second direction Y, and are aligned toward the upper right in the drawing.

When an electric field is thus formed between the pixel electrode PE and the common electrode CE in each of the pixels PX, more domains can be formed than in the example shown in FIG. 2, and the view angle can be increased.

The common electrode CE is formed as shown in FIG. 6, so that even if the primary common electrode CA or the secondary common electrode CB is partly broken, the probability that the common electrode may not partly function as an electrode can be reduced as compared with the example shown in FIG. 4. Moreover, the disturbance of the electric field applied to the liquid crystal layer LQ can be reduced, and the decrease of the display quality can be inhibited.

Furthermore, in the pixel PX shown in FIG. 7, the liquid crystal layer LQ has positive dielectric anisotropy. Therefore, the second alignment film AL2 is preferably formed so that the liquid crystal molecules LM located in the vicinity of the second alignment film AL2 are initially aligned in the second direction Y or a direction tilted at 20° or less from the second direction Y or in the first direction X or a direction tilted at 20° or less from the first direction X. The same applies to the case where the liquid crystal layer LQ has negative dielectric anisotropy, and the second alignment film AL2 is preferably formed as described above.

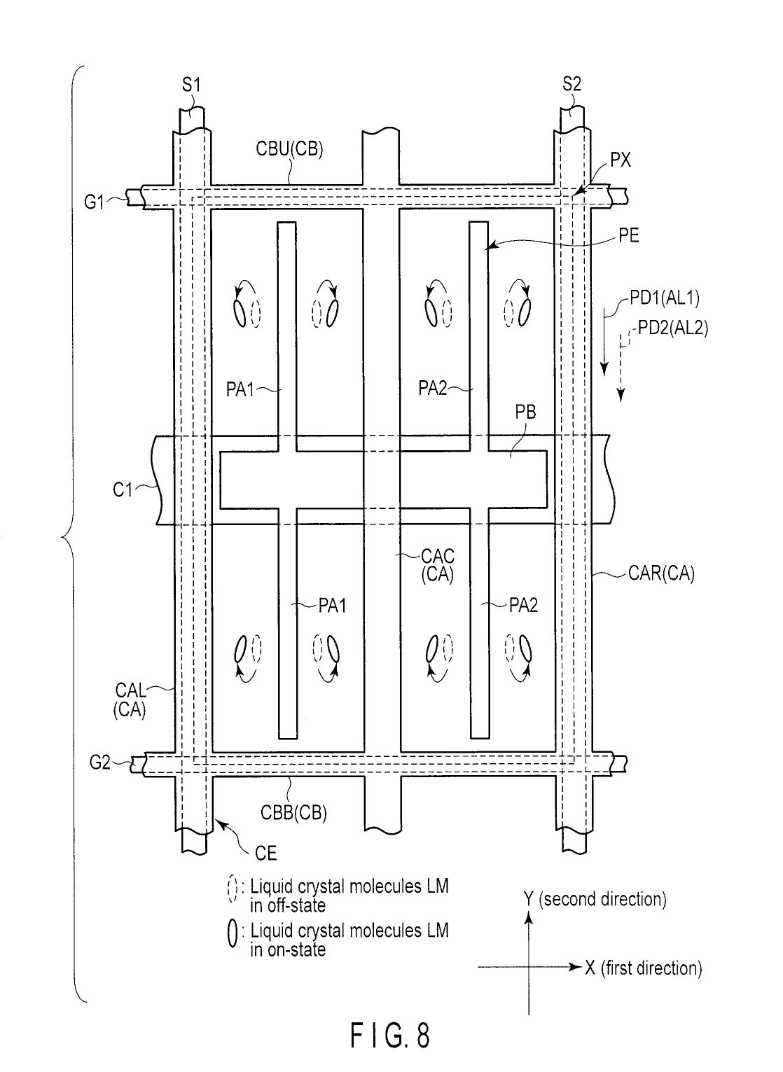

FIG. 8 is a plan view schematically showing another structure example of one pixel PX when the liquid crystal display panel LPN shown in FIG. 1 is viewed from the side of the countersubstrate, wherein the common electrode CE shown in FIG. 6 is shown together.

As shown in FIG. 8, the structure example of the pixel PX is different from the structure example shown in FIG. 7 in that the pixel electrode PE comprises the primary pixel electrodes PA arranged at intervals substantially parallel to each other in the first direction X and in that the primary common electrode CA is provided between the adjacent primary pixel electrodes PA.

That is, the pixel electrode PE comprises a primary pixel electrode PA1, a primary pixel electrode PA2, and a secondary pixel electrode PB. Primary pixel electrode PA1, primary pixel electrode PA2, and the secondary pixel electrode PB are electrically connected to one another. Primary pixel electrode PA1 and primary pixel electrode PA2 are arranged at intervals substantially parallel to each other in the first direction X. Primary pixel electrode PA1 and primary pixel electrode PA2 linearly extend in the second direction Y from the secondary pixel electrode PB to the vicinities of the upper and lower ends of the pixel PX. The secondary pixel electrode PB extends in the first direction X. The secondary pixel electrode PB is located in a area that opposes the auxiliary capacitive line C1, and is electrically connected to the switching element SW through the contact hole CH.

The common electrode CE comprises primary common electrode CAL, primary common electrode CAR, a primary common electrode CAC, the secondary common electrode CBB, and the secondary common electrode CBU. Primary common electrode CAL, primary common electrode CAR, a primary common electrode CAC, the secondary common electrode CBB, and the secondary common electrode CBU are electrically connected to one another.

Primary common electrode CAL, primary common electrode CAR, and primary common electrode CAC are arranged at intervals substantially parallel to each other in the first direction X, and extend in the second direction Y. In the pixel PX, primary common electrode CAL is located at the left end, primary common electrode CAR is located at the right end, and primary common electrode CAC is located between primary pixel electrode PA1 and primary pixel electrode PA2.

The secondary common electrode CBB and the secondary common electrode CBU are arranged at intervals substantially parallel to each other in the second direction Y, and extend in the first direction X. In the pixel PX, the secondary common electrode CBB is located at the lower end, and the secondary common electrode CBU is located at the upper end. The secondary pixel electrode PB is located between the secondary common electrode CBB and the secondary common electrode CBU.

With regard to the positional relation between the pixel electrode PE and the common electrode CE, the primary pixel electrode PA and the primary common electrodes CA are alternately arranged in the first direction X, and the secondary pixel electrode PB and the secondary common electrode CB are alternately arranged in the second direction Y. That is, one primary pixel electrode PA1 is located between primary common electrode CAL and primary common electrode CAC that are adjacent to each other, and one primary pixel electrode PA2 is located between primary common electrode CAC and primary common electrode CAR that are adjacent to each other. Primary common electrode CAL, primary pixel electrode PA1, primary common electrode CAC, primary pixel electrode PA2, and primary common electrode CAR are arranged in the first direction X in this order. One secondary pixel electrode PB is located between the secondary common electrode CBB and the secondary common electrode CBU that are adjacent to each other, and the secondary common electrode CBB, the secondary pixel electrode PB, and the secondary common electrode CBU are arranged in the second direction Y in this order.

The horizontal inter-electrode distance between primary common electrode CAL and primary pixel electrode PA1, the horizontal inter-electrode distance between primary common electrode CAC and primary pixel electrode PA1, the horizontal inter-electrode distance between primary common electrode CAC and primary pixel electrode PA2, and the horizontal inter-electrode distance between primary common electrode CAR and primary pixel electrode PA2 are substantially equal.

The liquid crystal layer LQ has positive dielectric anisotropy. In such a configuration example as well, a large number of domains can be formed in each of the pixels PX when the liquid crystal molecules LM initially aligned in the second direction Y in the off-state are formed between the pixel electrode PE and the common electrode CE in the on-state, and the view angle can be increased.

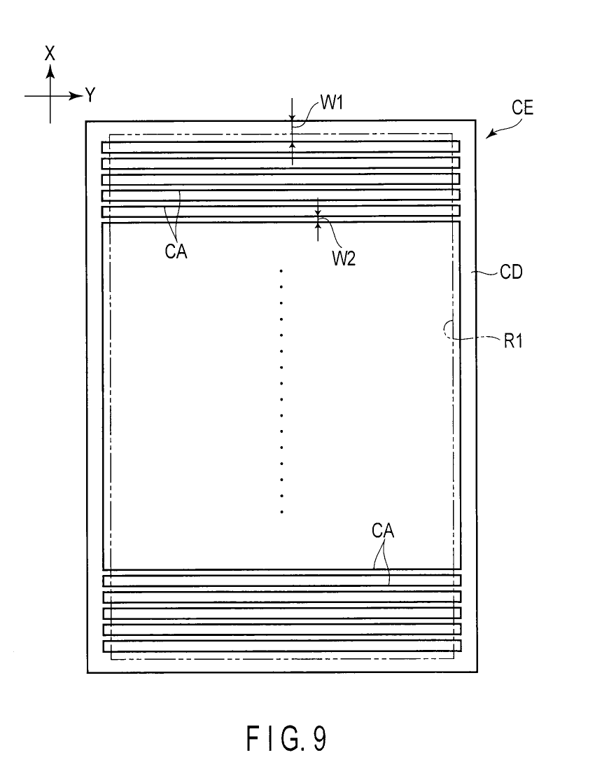

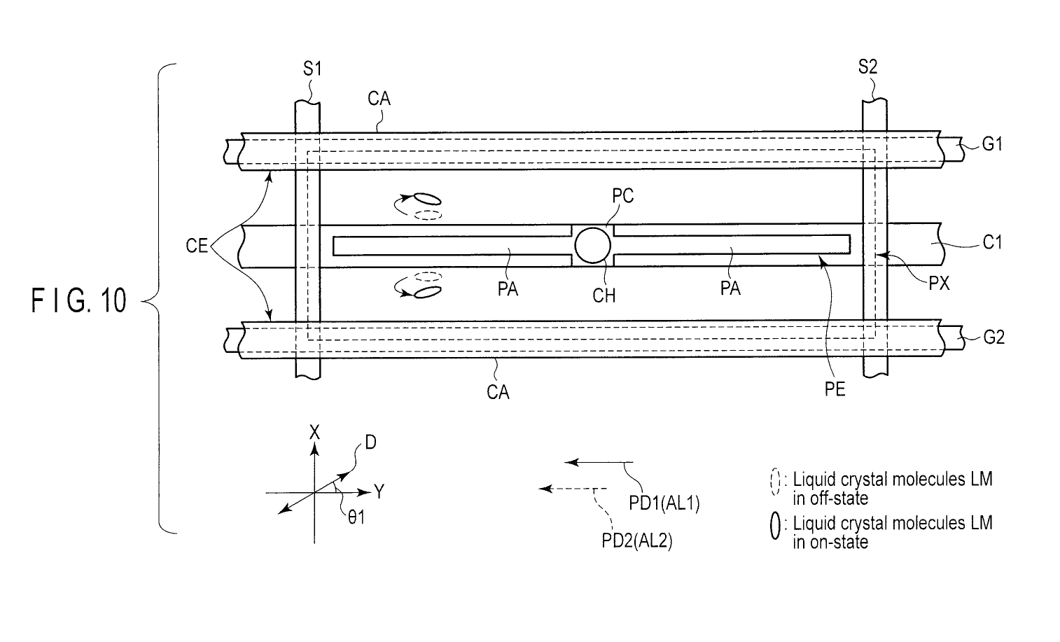

FIG. 9 is a plan view schematically showing another modification of the common electrode CE. FIG. 10 is a plan view schematically showing another structure example of one pixel when the liquid crystal display panel LPN shown in FIG. 1 is viewed from the side of the countersubstrate CT, wherein the common electrode CE shown in FIG. 9 is shown together.

As shown in FIG. 9 and FIG. 10, the primary pixel electrode PA and the primary common electrode CA may be formed to extend parallel to the gate lines G and the auxiliary capacitive lines C. For example, the gate lines G and the auxiliary capacitive lines C substantially linearly extend in the second direction Y. The gate lines G and the auxiliary capacitive lines C are alternately arranged parallel to one another in the first direction X. The source lines S substantially linearly extend in the first direction X. Although not shown, the color filter CF substantially linearly extends in the first direction X.

The gate lines G, the auxiliary capacitive lines C, and the source lines S do not necessarily have to linearly extend and may be partly bent. The primary common electrode CA is located to oppose the gate line G.

The common electrode CE is formed as shown in FIG. 9, so that even if the primary common electrode CA is partly broken, the probability that the common electrode may not partly function as an electrode can be reduced. Moreover, the disturbance of the electric field applied to the liquid crystal layer LQ can be reduced, and the decrease of the display quality can be inhibited.

Furthermore, in the pixel PX shown in FIG. 10, the liquid crystal layer LQ has positive dielectric anisotropy. Therefore, the first alignment film AL1 is preferably formed so that the liquid crystal molecules LM located in the vicinity of the first alignment film AL1 are initially aligned in the second direction Y or a direction tilted at 20° or less from the second direction Y. The second alignment film AL2 is preferably formed so that the liquid crystal molecules LM located in the vicinity of the second alignment film AL2 are initially aligned in the second direction Y or a direction tilted at 20° or less from the second direction Y.

The liquid crystal layer LQ may have negative dielectric anisotropy. In this case, the first alignment film AL1 is preferably formed so that the liquid crystal molecules LM located in the vicinity of the first alignment film AL1 are initially aligned in the first direction X or a direction tilted at 20° or less from the first direction X. The second alignment film AL2 is also preferably formed so that the liquid crystal molecules LM located in the vicinity of the second alignment film AL2 are initially aligned in the first direction X or a direction tilted at 20° or less from the first direction X.

In the present embodiment, the common electrode CE may comprise, in addition to the primary common electrode CA provided in the countersubstrate CT, a second primary common electrode (shield electrode) which is provided in the array substrate AR and which faces the primary common electrode CA (or faces the source line S). This second primary common electrode extends substantially parallel to the primary common electrode CA and is set to the same potential as the primary common electrode CA. An undesired electric field from the source line S can be blocked by providing the second primary common electrode.

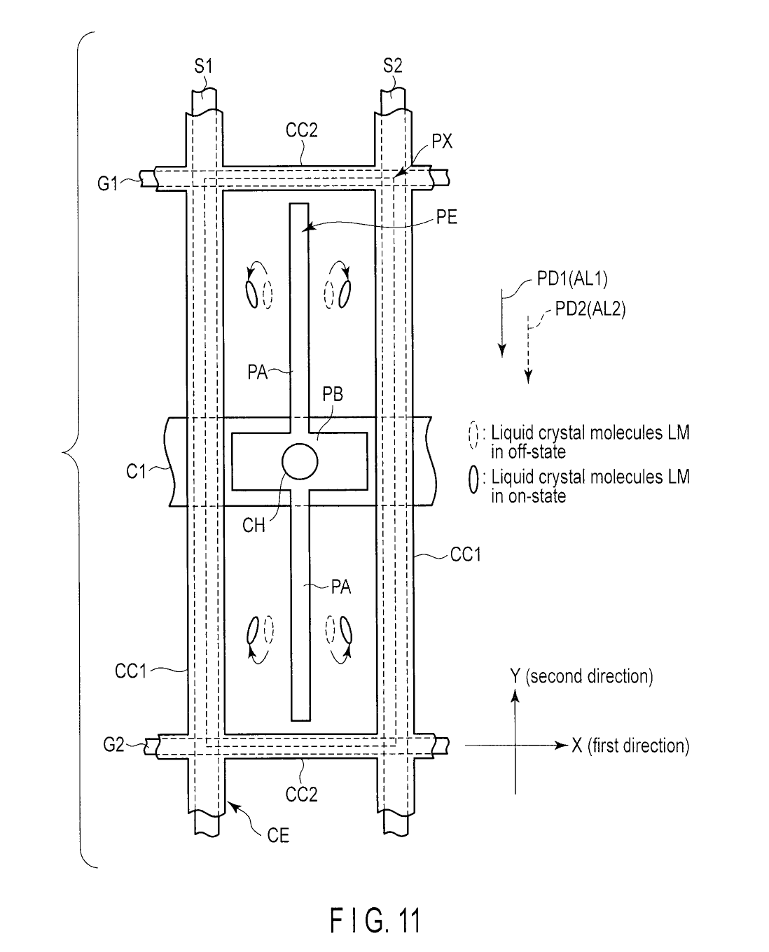

For example, as shown in FIG. 11, the array substrate AR further comprises a plurality of additional primary common electrodes CC1. The additional primary common electrodes CC1 are arranged at intervals in the first direction X, face the primary common electrodes CA (FIG. 7) and the source lines S (S1 and S2), and extend in the second direction Y, respectively.

The common electrode CE may comprise, in addition to the primary common electrode CA provided in the countersubstrate CT, a second secondary common electrode (shield electrode) which is provided in the array substrate AR and which faces the gate line G and the auxiliary capacitive line C. This second secondary common electrode extends a direction that intersects with the primary common electrode CA and is set to the same potential as the primary common electrode CA. An undesired electric field from the gate line G and the auxiliary capacitive line C can be blocked by providing the second secondary common electrode. According to the configuration provided with the second primary common electrode and the second secondary common electrode, it is possible to inhibit further deterioration of the display quality.

For example, as shown in FIG. 11, the array substrate AR further comprises a plurality of additional secondary common electrodes CC2. The additional secondary common electrodes CC2 are arranged at intervals in the second direction Y, sandwich the primary pixel electrodes PA in the second direction Y, and extend in the first direction X, respectively. In this example, the secondary common electrodes CC2 face the gate lines G (G1 and G2) and the secondary common electrodes CB (FIG. 7).

What is claimed is:

1. A liquid crystal display apparatus comprising:
a first substrate comprising a plurality of pixel electrodes;
a second substrate comprising a peripheral electrode and a common electrode;
a liquid crystal layer held between the first substrate and the second substrate; and
a display area opposing the first substrate, the second substrate, and the liquid crystal layer,
wherein the pixel electrodes comprise a plurality of primary pixel electrodes arranged in the display area at intervals in a first direction and a second direction which cross at right angles, and extending in the second direction,
the peripheral electrode has a frame shape around an outer periphery of the display area, and
the common electrode comprises a plurality of primary common electrodes arranged at intervals in the first direction to sandwich the primary pixel electrodes in the first direction, and extending in the second direction, wherein both ends of each of the primary common electrodes are connected with the peripheral electrode.

2. The liquid crystal display apparatus according to claim 1, wherein the common electrode further comprises a plurality of secondary common electrodes, the secondary common electrodes are arranged at intervals in the second direction to sandwich the primary pixel electrodes in the second direction, and extend in the first direction, wherein both ends of each of the secondary common electrodes are connected with the peripheral electrode, and the secondary common electrodes are formed integrally with the primary common electrodes and the peripheral electrode.

3. The liquid crystal display apparatus according to claim 2, wherein the liquid crystal layer has positive dielectric anisotropy,
the first substrate further comprises a first alignment film configured to initially align liquid crystal molecules in the second direction or a direction tilted at 20° or less from the second direction, and
the second substrate further comprises a second alignment film configured to initially align the liquid crystal molecules in the second direction or a direction tilted at 20° or less from the second direction, or in the first direction or a direction tilted at 20° or less from the first direction.

4. The liquid crystal display apparatus according to claim 2, wherein the liquid crystal layer has negative dielectric anisotropy,
the first substrate further comprises a first alignment film configured to initially align liquid crystal molecules in the first direction or a direction tilted at 20° or less from the first direction, and
the second substrate further comprises a second alignment film configured to initially align the liquid crystal molecules in the first direction or a direction tilted at 20° or less from the first direction.

5. The liquid crystal display apparatus according to claim 2, wherein the first substrate further comprises a plurality of additional primary common electrodes arranged at intervals in the first direction, facing the primary common electrodes and extending in the second direction.

6. The liquid crystal display apparatus according to claim 5, wherein the first substrate further comprises a plurality of additional secondary common electrodes arranged at intervals in the second direction to sandwich the primary pixel electrodes in the second direction and extending in the first direction.

7. The liquid crystal display apparatus according to claim 1, wherein the first substrate further comprises
a plurality of source lines arranged in the display area at intervals in the first direction, extending in the second direction, and opposing the primary common electrodes, and
a plurality of gate lines arranged in the display area at intervals in the second direction, and extending along the first direction.

8. The liquid crystal display apparatus according to claim 1, wherein the first substrate further comprises
a plurality of gate lines arranged in the display area at intervals in the first direction, extending in the second direction, and opposing the primary common electrodes, and
a plurality of source lines arranged in the display area at intervals in the second direction, and extending in the first direction.

9. The liquid crystal display apparatus according to claim 1, wherein the width of the peripheral electrode is larger than the width of the primary common electrode.

10. A liquid crystal display apparatus comprising:
a first substrate comprising a plurality of pixel electrodes;
a second substrate comprising a peripheral electrode and a common electrode;
a liquid crystal layer held between the first substrate and the second substrate; and
a display area opposing the first substrate, the second substrate, and the liquid crystal layer,
wherein the pixel electrodes comprise a plurality of primary pixel electrodes arranged in the display area at intervals in a first direction and a second direction which cross at right angles, and extending in the second direction, and a plurality of secondary pixel electrodes extending in the first direction, each of the pixel electrodes having a cross-shaped,
the peripheral electrode has a frame shape around an outer periphery of the display area, and
the common electrode comprises a plurality of primary common electrodes arranged at intervals in the first direction to sandwich the primary pixel electrodes in the first direction, and extending in the second direction, wherein both ends of each of the primary common electrodes are connected with the peripheral electrode, and a plurality of secondary common electrodes arranged at intervals in the second direction to sandwich the primary pixel electrodes in the second direction, and extending in the first direction, wherein both ends of each of the secondary common electrodes are connected with the peripheral electrode, the common electrode having a lattice-shaped.

11. The liquid crystal display apparatus according to claim 10, wherein the liquid crystal layer is surrounded by a sealing member, and the peripheral electrode extends up to the sealing member.

12. The liquid crystal display apparatus according to claim 11, wherein liquid crystal molecules in the liquid crystal layer have positive dielectric anisotropy,
the first substrate further comprises a first alignment film configured to initially align the liquid crystal molecules in a direction tilted at 20° or less from the primary pixel electrode, and
the second substrate further comprises a second alignment film configured to initially align the liquid crystal molecules in a direction tilted at 20° or less from the primary common electrode.

13. The liquid crystal display apparatus according to claim 11, wherein liquid crystal molecules in the liquid crystal layer have positive dielectric anisotropy,
the first substrate comprises a first alignment film configured to initially align the liquid crystal molecules in a direction parallel to the primary pixel electrode, and
the second substrate comprises a second alignment film configured to initially align the liquid crystal molecules in a direction parallel to the initial alignment direction of the first alignment film.

14. The liquid crystal display apparatus according to claim 11, wherein liquid crystal molecules in the liquid crystal layer are configured to be splay-aligned.

15. A liquid crystal display apparatus comprising:
a countersubstrate comprising a frame-shaped peripheral electrode, a primary common electrode connected with the peripheral electrode, and a secondary common electrode configured to intersect with the primary common electrode and connected with the peripheral electrode;
an array substrate comprising a pixel electrode configured to be located parallel to the primary common electrode;
a liquid crystal layer held between the countersubstrate and the array substrate and having a thickness smaller than the distance between the primary common electrode and the pixel electrode; and
a sealing member surrounding the liquid crystal layer and opposing the end of the peripheral electrode.

16. The liquid crystal display apparatus according to claim 15, wherein the width of the peripheral electrode is larger than the width of the primary common electrode.

17. The liquid crystal display apparatus according to claim 15, wherein the pixel electrode comprises a primary pixel electrode located parallel to the primary common electrode, and a secondary pixel electrode located parallel to the secondary common electrode and connected with the primary pixel electrode.

18. The liquid crystal display apparatus according to claim 17, wherein the primary pixel electrode and the secondary pixel electrode cross at right angles.

19. The liquid crystal display apparatus according to claim 17, wherein liquid crystal molecules in the liquid crystal layer have positive dielectric anisotropy,
the array substrate further comprises a first alignment film configured to initially align the liquid crystal molecules in a direction tilted at 20° or less from the primary pixel electrode, and
the countersubstrate further comprises a second alignment film configured to initially align the liquid crystal molecules in a direction tilted at 20° or less from the primary common electrode.

20. The liquid crystal display apparatus according to claim 17, wherein liquid crystal molecules in the liquid crystal layer have positive dielectric anisotropy,
the array substrate comprises a first alignment film configured to initially align the liquid crystal molecules in a direction parallel to the primary pixel electrode, and
the countersubstrate comprises a second alignment film configured to initially align the liquid crystal molecules in a direction parallel to the initial alignment direction of the first alignment film.

21. The liquid crystal display apparatus according to claim 17, wherein liquid crystal molecules in the liquid crystal layer are configured to be splay-aligned.
